(19) United States
(12) Patent Application Publication
(10) Pub. No.: US 2021/0172491 A1
(43) Pub. Date: Jun. 10, 2021

(54) VULCANIZED SUPPORT RING FOR HYBRID AIR SPRING BELLOW

(71) Applicant: Continental Automotive Systems, Inc., Auburn Hills, MI (US)

(72) Inventors: Joseph G. Jerisk, Burton, MI (US); Garrett M. Pniewski, Bloomfield Hills, MI (US); Kranti Kiran Manga, Rochester Hills, MI (US)

(21) Appl. No.: 16/709,276

(22) Filed: Dec. 10, 2019

(51) Int. Cl. F16F 9/04; B60G 11/27

(52) U.S. Cl. CPC F16F 9/0463; B60G 2204/126; B60G 2204/125; B60G 11/27

(57) ABSTRACT

An air spring assembly includes bellow with an outer ring disposed on an outer surface of the bellow. The outer ring containing an embedded cord for constraining a portion of the bellow to establish a “B” shaped fold in an inflated bellow.

### TECHNICAL FIELD

The present disclosure relates to air spring assemblies for a vehicles with a hybrid bellow configuration.

### BACKGROUND

An air spring assembly for a motor vehicle includes a bellow filled with air to support the vehicle and absorb road inconsistencies. A hybrid bellow includes an outer support ring that is crimped to an inner support ring to provide a “B” shape in the bellow. The inner and outer support rings can complicate assembly and manufacture.

### SUMMARY

An air spring assembly according to a non-limiting exemplary embodiment includes, among other possible things, a bellow including an outer surface, a first end and a second end, wherein the bellow comprises a rubber material that is expandable to an inflated diameter and an outer ring disposed on the outer surface of the bellow between the first end and the second end, the outer ring containing an embedded cord to define a constrained portion of the bellow between expanded portions to establish a “B” fold in the bellow.

In another disclosed embodiment of the foregoing air spring assembly, the outer ring comprises a rubber material containing the cord.

In another disclosed embodiment of any of the foregoing air spring assemblies, the cord comprises at least one synthetic fiber cord.

In another disclosed embodiment of any of the foregoing air spring assemblies, the outer ring includes at least one synthetic fiber cord that is vulcanized onto the bellow.

In another disclosed embodiment of any of the foregoing air spring assemblies, the bellow comprises a first elasticity and the outer ring comprises a second elasticity that is less than the first elasticity.

In another disclosed embodiment of any of the foregoing air spring assemblies, the constrained portion comprises a constrained diameter that is less than the inflated diameter.

In another disclosed embodiment of any of the foregoing air spring assemblies, the outer ring comprises a rubber strip surrounding the cord that is vulcanized to the outer surface of the bellow.

In another disclosed embodiment of any of the foregoing air spring assemblies, the cord comprises a woven bundle of cords.

In another disclosed embodiment of any of the foregoing air spring assemblies, the bellow and outer ring comprise a single unitary part.

A method of forming a bellow for an air spring assembly according to another non-limiting exemplary embodiment of this disclosure includes, among other possible things, forming a bellow from a rubber material to include an outer surface, a first end and a second end, wrapping a cord around a portion of the bellow and encasing the cord in a rubber material to affix the cord to the outer surface of the bellow in a vulcanization process.

In another disclosed embodiment of the foregoing method, including forming an outer ring of rubber material around the cord such that the cord is embedded within the outer ring.

In another disclosed embodiment of any of the foregoing methods, the cord comprises at least one synthetic fiber cord.

In another disclosed embodiment of any of the foregoing methods, the cord comprises a woven bundle of cords.

In another disclosed embodiment of any of the foregoing methods, the cord includes an elasticity that is less than an elasticity of the rubber material forming the bellow to define a constrained portion of the bellow between expandable portions to establish a “B” fold in the completed bellow.

In another disclosed embodiment of any of the foregoing methods, the constrained portion comprises a constrained diameter that is less than expandable portions.

In another disclosed embodiment of any of the foregoing methods, wrapping the cord includes wrapping the cord with a rubber strip and vulcanizing the rubber strip to the outer surface of the bellow to encase the cord.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of a portion of an example air spring assembly embodiment.

FIG. 2 is a schematic view of an enlarged portion of the example air spring assembly.

FIG. 3 is a sectional view of a portion of an example outer ring embodiment.

FIG. 4 is a top view of an example cord assembly of the outer ring.

FIG. 5 is a cross-section of another example outer ring embodiment.

FIG. 6 is a cross-section of yet another example outer ring embodiment.

FIG. 7 is a schematic view of an example method for forming a bellow.

### DETAILED DESCRIPTION

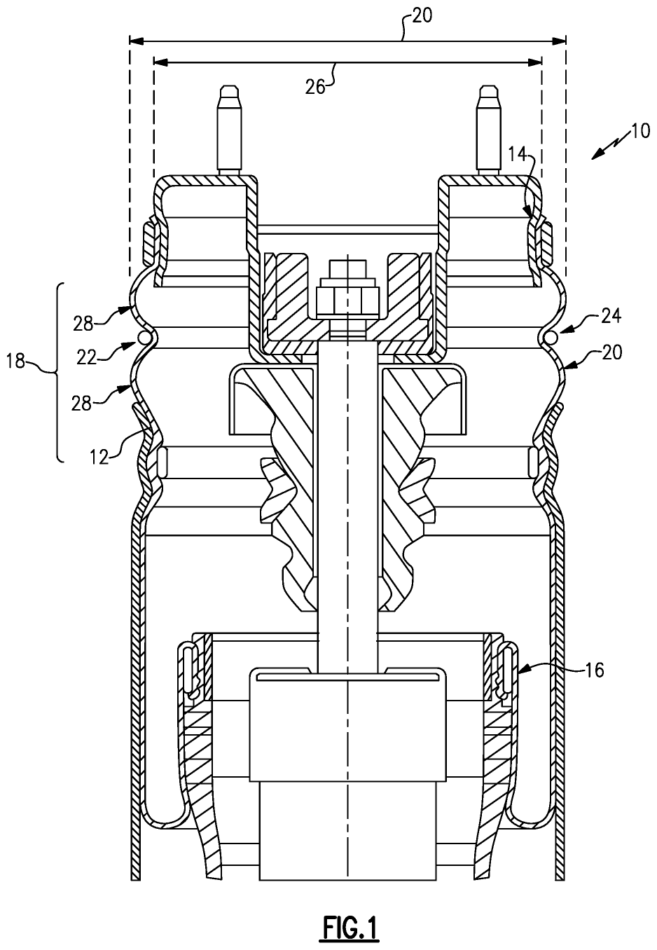

Referring to FIG. 1, an example air spring assembly 10 includes a bellow 12 with a “B” shaped fold 18. The “B” shaped fold 18 is disposed between a first end 14 and a second end 16 of the bellow 12. The “B” shaped fold provides a desired suspension that decouples torsion and kinematics of the air spring assembly 10. The “B” shaped fold 18 is defined by a constrained portion 22 disposed between expanded regions 28. The constrained portion 22 is formed by an outer ring 24 disposed about an outer surface 30 of the bellow 12. The bellow 10 expands to an inflated diameter 20 within the expanded regions 28. The constrained portion 22 is held at a diameter 26 that is less than the inflated diameter 20.

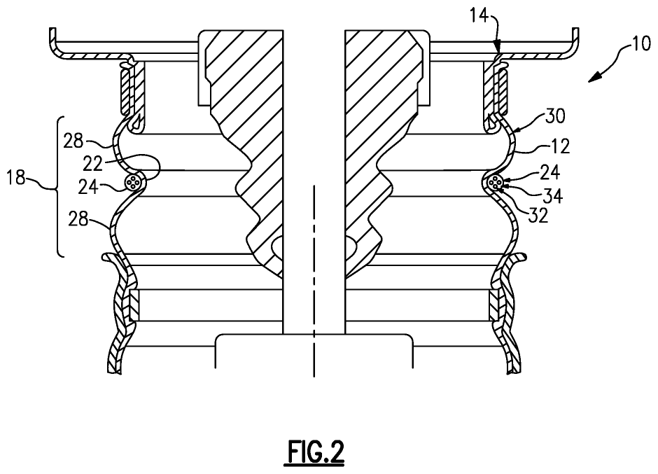

Referring to FIG. 2, with continued reference to FIG. 1, the outer ring 24 includes at least one cord 32 encapsulated within a rubber material 34. In one disclosed example embodiment, the rubber material 34 of the outer ring 24 is the same as is utilized to form the bellow 12. The cord 32 includes an elasticity that is much less than that of the bellow 12 to constrain expansion beyond the diameter 26 in the constrained region.

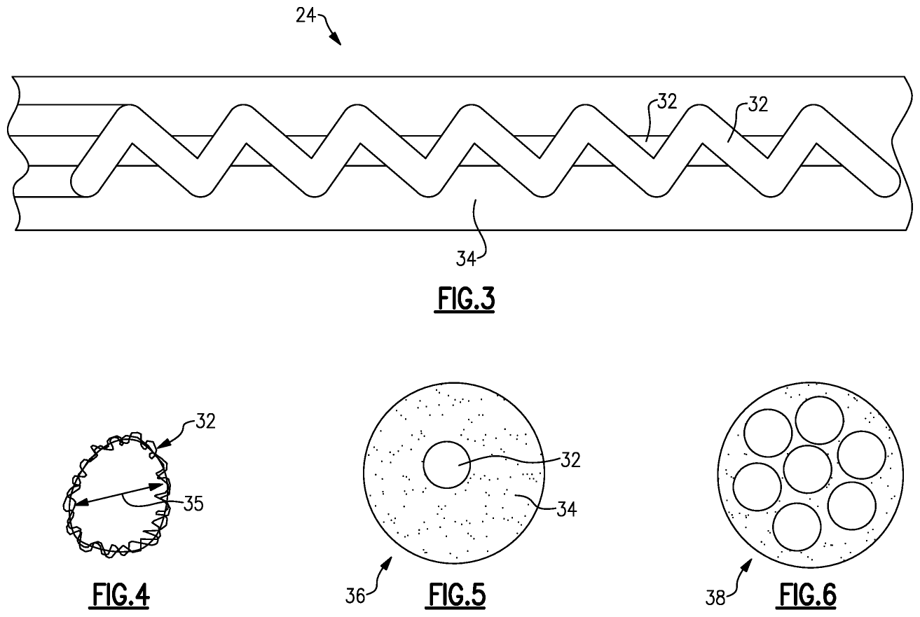

Referring to FIGS. 3 and 4, with continued reference to FIG. 2, the disclosed example outer ring 24 includes cords 32 in a woven configuration that extend about a circumference of the outer ring 24. The example cords 32 are formed from a synthetic material with a limited capacity to expand relative to the rubber material forming the bellow 12. The synthetic material may include any synthetic material that is compatible with the rubber material and has limited elasticity. The cords 32 may be formed as a loop of many cords attached to each other to define the desired diameter of the constrained portion 22. In the disclosed example, the woven cords 32 define a maximum diameter 35 (FIG. 4).

Referring to FIG. 5, another example outer ring embodiment is schematically shown and indicated at 36. The example outer ring 36 includes a single cord 32 that is encapsulated in the rubber material 34.

Referring to FIG. 6, another example outer ring embodiment is schematically shown and indicated at 38. The example outer ring 38 includes several cords 32 that are also encapsulated within a rubber material 34. It should be appreciated that although several outer ring embodiments are shown by way of example, that other configurations, numbers and shapes of cords 32 can be utilized within the scope and contemplation of this disclosure.

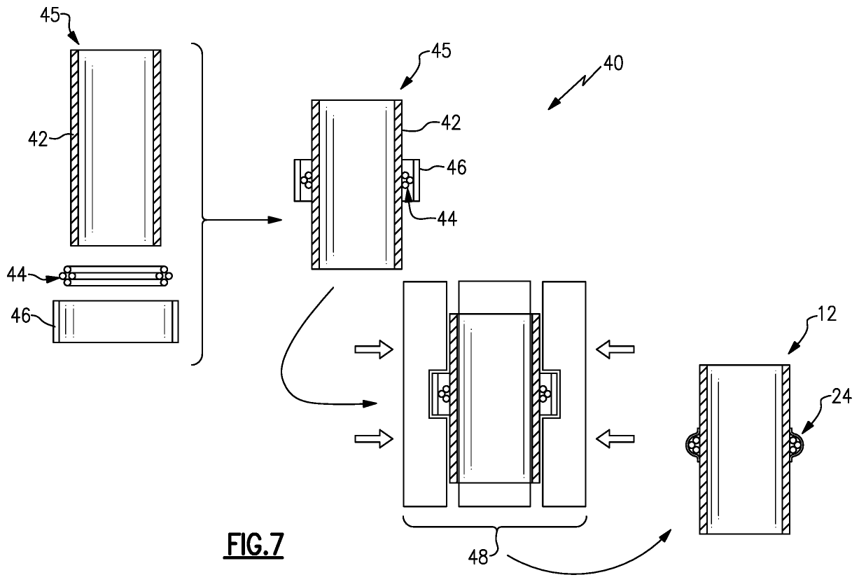

Referring to FIG. 7, an example method of forming a bellow for an air spring is schematically shown and indicated at 40. The example method includes forming a bellow 45 of a rubber material 42. In this example, the rubber material 42 is in a pre-vulcanization state. Vulcanization is a known process utilized to treat the rubber material 42 to increase durability and flexibility. The example method forms the outer ring 24 during the vulcanization process to provide a single integral bellow 12 with the outer ring 24. A single cord or a plurality of cords 44 are installed and positioned onto the bellow 45 and surrounded by a rubber strip 46. The cords 44 may be wrapped or slid over the outside of the bellow 45.

The bellow 45 with the cords 44 and the rubber strip 46 are then placed within a tool 48 for vulcanization. The tool 48 may apply pressure to bond the rubber strip 46 over the cords 44 and to the bellow 45. During vulcanization, the rubber strip 44 encapsulates the cords 44 and affixes to the outer surface of the bellow 45. The vulcanization tool 48 and process are disclosed by way of example. Any known vulcanization process may be utilized and are within the scope and contemplation of this disclosure.

The completed bellow 12 is removes from the vulcanization tool 48 and includes the outer ring 24. The outer ring 24 becomes an integral part of the completed bellow 12 and constrains a portion of the bellow 12 to define the desired “B” shaped fold 18 when inflated during operation and use of the air spring 10.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. An air spring assembly comprising:
a bellow including an outer surface, a first end and a second end, wherein the bellow comprises a rubber material that is expandable to an inflated diameter; and
an outer ring disposed on the outer surface of the bellow between the first end and the second end, the outer ring containing an embedded cord to define a constrained portion of the bellow between expanded portions to establish a “B” fold in the bellow.

2. The air spring assembly as recited in claim 1, wherein the outer ring comprises a rubber material containing the cord.

3. The air spring assembly as recited in claim 2, wherein the cord comprises at least one synthetic fiber cord.

4. The air spring assembly as recited in claim 3, wherein the outer ring including the at least one synthetic fiber cord is vulcanized onto the bellow.

5. The air spring assembly as recited in claim 2, wherein the bellow comprises a first elasticity and the outer ring comprises a second elasticity that is less than the first elasticity.

6. The air spring assembly as recited in claim 1, wherein the constrained portion comprises a constrained diameter that is less than the inflated diameter.

7. The air spring assembly as recited in claim 1, wherein the outer ring comprises a rubber strip surrounding the cord that is vulcanized to the outer surface of the bellow.

8. The air spring assembly as recited in claim 7, wherein the cord comprises a woven bundle of cords.

9. The air spring assembly as recited in claim 1, wherein the bellow and outer ring comprise a single unitary part.

10. A method of forming a bellow for an air spring assembly comprising:
forming a bellow from a rubber material to include an outer surface, a first end and a second end; and
wrapping a cord around a portion of the bellow; and
encasing the cord in a rubber material to affix the cord to the outer surface of the bellow in a vulcanization process.

11. The method as recited in claim 10, including forming an outer ring of rubber material around the cord such that the cord is embedded within the outer ring.

12. The method as recited in claim 11, wherein the cord comprises at least one synthetic fiber cord.

13. The method as recited in claim 11, wherein the cord comprises a woven bundle of cords.

14. The method as recited in claim 10, wherein the cord includes an elasticity that is less than an elasticity of the rubber material forming the bellow to define a constrained portion of the bellow between expandable portions to establish a “B” fold in the completed bellow.

15. The method as recited in claim 14, wherein the constrained portion comprises a constrained diameter that is less than expandable portions.

16. The method as recited in claim 10, wherein wrapping the cord includes wrapping the cord with a rubber strip and vulcanizing the rubber strip to the outer surface of the bellow to encase the cord.
